(19) United States
(12) Patent Application Publication
(10) Pub. No.: US 2014/0348317 A1
(43) Pub. Date: Nov. 27, 2014

(54) METHOD AND APPARATUS FOR PRESENTING INFORMATION FROM MULTIPLE TELECOMMUNICATION COMPUTER SOFTWARE PROGRAMS IN A SINGLE COMPUTER SOFTWARE PROGRAM

(71) Applicant: Varahur Srikantan Deepak, Banagalore (IN)

(72) Inventor: Varahur Srikantan Deepak, Banagalore (IN)

(21) Appl. No.: 13/898,573

(22) Filed: May 21, 2013

(51) Int. Cl. H04M 3/51

(52) U.S. Cl. CPC H04M 3/5183
USPC 379/265.09

(57) ABSTRACT

A method including receiving a telecommunications call from a customer at a contact center, and in response to the telecommunications call, using a first user computer to request customer data from a software cache in a computer memory related to a first computer software application. The method may further include, if the customer data is in the software cache, retrieving the customer data from the software cache and storing the customer data in a base enterprise computer software application. If the customer data is not in the software cache, the method may include searching for the customer data in the base enterprise computer software application, if the customer data is in the base enterprise computer software application, retrieving the customer data from the base enterprise computer software application and storing the customer data in the software cache in the computer memory related to the first computer software application.

### FIELD OF THE INVENTION

This invention relates to improved methods and apparatus relating to computer software.

### BACKGROUND OF THE INVENTION

Telecommunications has led to the sudden growth of communication service providers, such as telecommunications operators across the globe. Due to the speed of growth and advancements in technology, telecommunications operators have either bought, or built themselves in house, many different software products and solutions to cater to specific needs at various points in time. After running their operations for a while, the operator's information technology (IT) ecosystem included a wide variety of software products and solutions that were from different vendors and suppliers. These solutions were completely different from each other in terms of tools used and design executed, and hence, incompatible with each other in one or another way.

There have been various prior solutions to making these different software products compatible with each other, but they have proved to be in-adequate.

### SUMMARY OF THE INVENTION

One or more embodiments of the present invention provide methods and apparatus for presenting information from multiple telecommunication computer software programs and/or systems in a single computer software program and/or system.

In at least one embodiment, an apparatus and a method is provided which retains the advantages of the Mash-up solutions and does away with the disadvantages. After a careful study and analysis of the various queries and service requests that subscribers typically have while contacting a telecommunications operator, the inventors of the present application determined that for every call, there is a certain set of data that has be to retrieved every time. This data typically pertains to the profile information of the subscriber, his geographical information and his personal details. This information rarely changes during the lifecycle of the subscriber.

In at least one embodiment, a smart data cache cluster is created, where this information is stored in computer memory and can be retrieved very quickly, without any dependency on the underlying computer software application or system.

The present invention, in at least one embodiment, has at least the following advantages, firstly, significant set of customer information data is stored in the cache cluster in computer memory, thus enabling a quick retrieval without having to connect to underlying computer software system like a customer relationship management system. Secondly, reduced load on the underlying systems due to lesser frequency of hits. Thirdly, even if an underlying computer software system is down, the cached/certain information available in the cache cluster can still be displayed. This enables contact center users with available information even during periods where base applications are temporarily unavailable.

One or more embodiments of the present invention provide a method. The method may include receiving a telecommunications call from a customer at a contact center. The method may further include, in response to the telecommunications call, using a first user computer to request customer data from a software cache in a computer memory related to a first computer software application. The method may further include, if the customer data is in the software cache, retrieving the customer data from the software cache and storing the customer data in a base enterprise computer software application. If the customer data is not in the software cache, the method may include searching for the customer data in the base enterprise computer software application, if the customer data is in the base enterprise computer software application, retrieving the customer data from the base enterprise computer software application and storing the customer data in the software cache in the computer memory related to the first computer software application.

In at least one embodiment, an apparatus comprising a computer processor; and a computer memory. The computer processor may be programmed such that in response to a telecommunications call from a customer, the computer processor requests customer data related to the customer from a software cache in a computer memory related to a first computer software application. The computer processor may be programmed, such that, if the customer data is in the software cache, the computer processor retrieves the customer data from the software cache and stores the customer data in a base enterprise computer software application. The computer processor may be further programmed such that, if the customer data is not in the software cache, the computer processor searches for the customer data in the base enterprise computer software application, and if the customer data is in the base enterprise computer software application, the computer processor retrieves the customer data from the base enterprise computer software application and stores the customer data in the software cache in the computer memory related to the first computer software application.

### BRIEF DESCRIPTION OF THE DRAWINGS

FIG. 1 shows a block diagram of a first generation prior art approach to organizing multiple computer software applications accessed by a customer service representative when answering a customer query;

FIG. 2 shows a block diagram of a second generation prior art approach to organizing multiple computer software applications accessed by a customer service representative;

FIG. 3 shows a block diagram of a user computer and a server computer, in communication via the internet, for use in accordance with one or more embodiments of the present invention;

FIG. 4 shows a block diagram of an apparatus and/or method for organizing multiple computer software applications accessed by a customer service representative in accordance with one or more embodiments of the present invention;

FIG. 5 shows another block diagram of another apparatus and/or method for organizing multiple computer software applications accessed by a customer service representative in accordance with one or more further embodiments of the present invention; and

FIG. 6 shows a block diagram of flow chart of a method in accordance with one or more embodiments of the present invention.

### DETAILED DESCRIPTION OF THE DRAWINGS

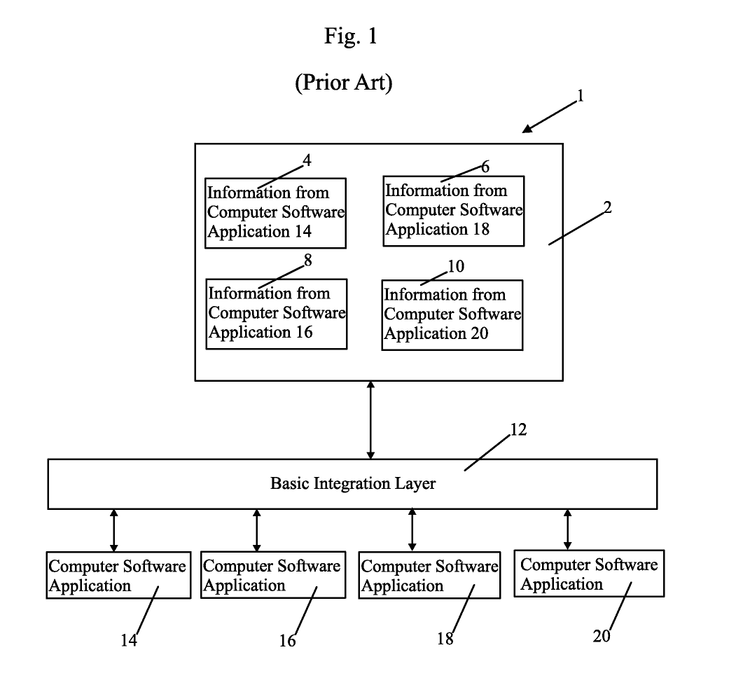

FIG. 1 shows a block diagram 1 of a first generation prior art approach to organizing multiple computer software applications accessed by a customer service representative. The block diagram 1 shows computer software application 14, computer software application 16, computer software application 18, and computer software application 20. Each of the computer software applications may be executed by a computer processor, may be stored in computer memory, and may be displayed on a computer display. Each of the computer software applications 14, 16, 18, and 20 may be different from one another. The computer software applications 14, 16, 18, and 20 communicate with and/or are linked to a basic integration layer 12. The basic integration layer 12 may include computer software executed by a computer processor, stored in a computer memory, and displayed on a computer display. The basic integration layer 12 may have a mechanism to bring together information from applications 14, 16, 18, and 20 together. The basic integration layer may be linked to and/or may communicate with a computer monitor and/or computer 2. The computer and/or computer monitor 2 may display information about the computer software applications 14, 16, 18, and 20, in windows 4, 6, 8, and 10, respectively. This information may include subscriber information like service request history, call records, payment details, and other information.

A customer service representative (CSR) using the first generation prior art apparatus and method shown by FIG. 1, has to access multiple systems, such as of applications 14, 16, 18, and 20, when subscribers call a call center for any queries or service requests. Using the apparatus and method of FIG. 1, a CSR may need to access, by displaying on computer or computer monitor 2, more than three to four different computer software systems (in this case four shown in windows 4, 6, 8, and 10 for applications 14, 16, 18, and 20) to effectively address customer queries and requests put forward by a subscriber. Additionally, every time a new CSR joins an organization, an operator typically has to train a new CSR on these multiple computer software products and solutions, such as 14, 16, 18, and 20. The applications 14, 16, 18 and 20 may be computer software programs and/or systems such as known computer programs or systems for billing systems, CRM (customer relationship management) systems, prepaid systems, order management systems, or VAS (virtual address systems) systems. Training would also have to be provided to all CSRs when one of these computer software applications, such as of 14, 16, 18, and 20, were either replaced or majorly upgraded.

Generally speaking, for the FIG. 1 prior art technique, the CSR needs to be trained on multiple computer software applications; the CSR needs to be trained on computer software applications whenever there is a change or upgrade in a particular computer software application; and also CSR takes more time to respond to queries as a result of accessing multiple computer software applications. Also, if one computer software application is down, such as computer software application 14, the CSR cannot manage queries related to that application.

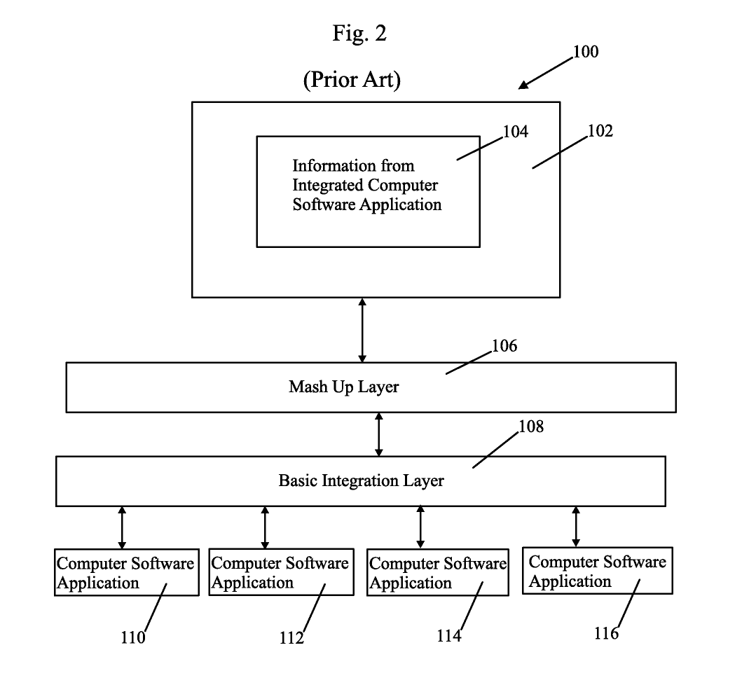

FIG. 2 shows a block diagram 100 of a second generation prior art approach to organizing multiple computer software applications accessed by a customer service representative.

The block diagram 100 shows computer software application 110 computer software application 112, computer software application 114, and computer software application 116. Each of the computer software applications may be executed by a computer processor, may be stored in computer memory, and may be displayed on a computer display. Each of the computer software applications 110, 112, 114, and 116 may be different from one another. The computer software applications 110, 112, 114, and 116 communicate with and/or are linked to a basic integration layer 108. The basic integration layer 108 may include computer software executed by a computer processor, stored in a computer memory, and displayed on a computer display. The basic integration layer 108 may integrate the applications 110, 112, 114, and 116 together. The basic integration layer 108 may be linked to and/or may communicate with a mash up layer 106. The mash up layer may collate information from computer software applications 110, 112, 114, and 116 each and every time it is requested, and provide information to window 104 of the computer and/or computer monitor 102.

In the second generation prior art approach of FIG. 2, CSRs are provided with just one system or solution, through interface or window 104, that can retrieve comprehensive information about a subscriber or about a plurality of subscribers from multiple underlying computer software application systems, and present it to the CSR in one single computer software application provided by Mash up Layer 106 through interface or window 104. Mash-up solutions, such as shown by FIG. 2, enable a higher level of integration with the underlying computer software (in this example 110, 112, 114, and 116) systems, consolidated all the information into one system and presented the same to the CSR through window 104. The CSR could also use the same system, provided through window 104, to push information back into the underlying systems, such as 110, 112, 114, and 116.

The approach of FIG. 2 has the following problems. The load on the underlying computer software systems or computer software application programs 110, 112, 114, and 116 remains the same compared to the approach in FIG. 1, since the Mash-up solution integrated with them for every input and output request. If any of the underlying computer software systems or applications of applications 110, 112, 114, and 116, were down for any reason, the Mash-up solution would have challenges in displaying that part of the information in window 104 via mash up layer 106.

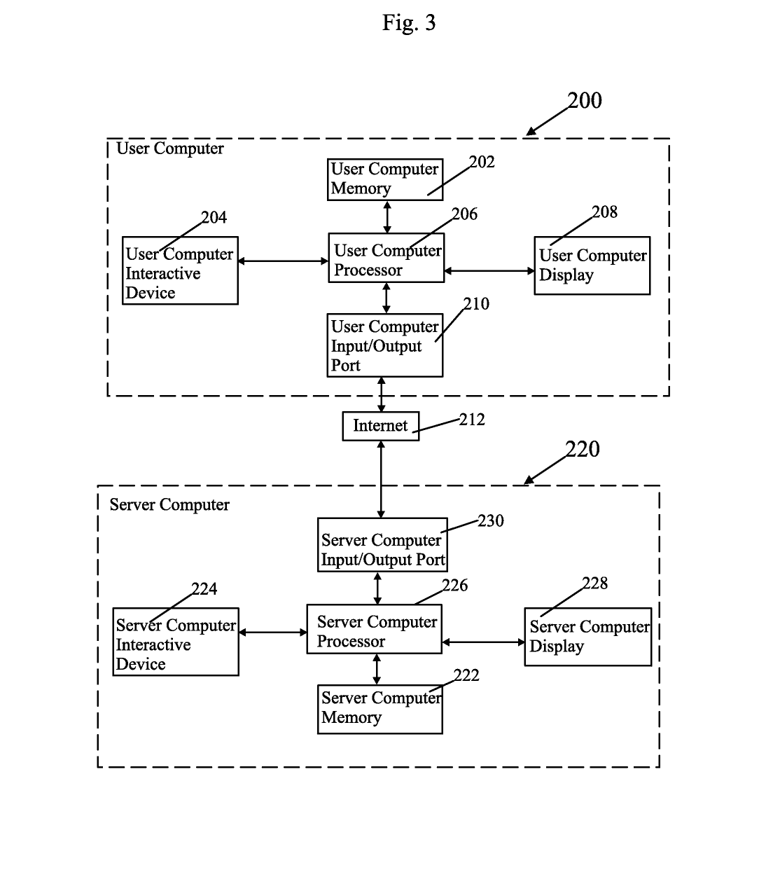

FIG. 3 shows a block diagram of a user computer 200 and a server computer 220, in communication via the internet 212, for use in accordance with one or more embodiments of the present invention. The user computer 200 includes a user computer memory 202, a user computer interactive device 204, a user computer processor 206, a user computer display 208, and a user computer input/output port 210. The user computer interactive device 204 may be a computer touch screen, a computer keyboard, and/or a computer mouse, and/or any other type of computer interactive device.

The server computer 220 includes a server computer memory 222, a server computer interactive device 224, a server computer processor 226, a server computer display 228, and a server computer input/output port 230. The server computer interactive device 224 may be a computer touch screen, a computer keyboard, and/or a computer mouse, and/or any other type of computer interactive device.

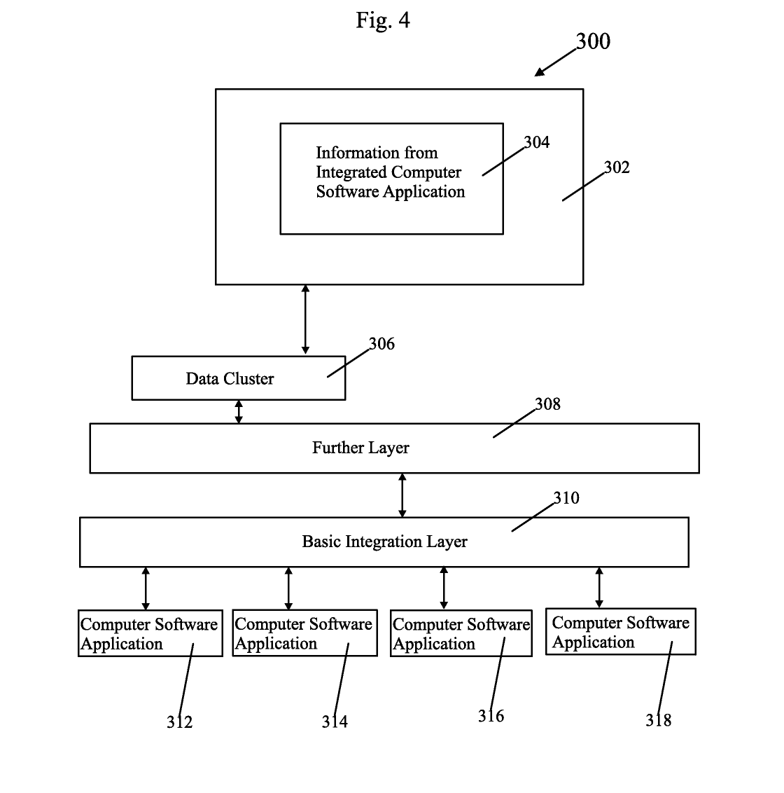

FIG. 4 shows a block diagram 300 of an apparatus and/or method for organizing multiple computer software applications accessed by a customer service representative in accordance with one or more embodiments of the present invention.

The block diagram 300 shows computer software application 312, computer software application 314, computer software application 316, and computer software application 318. Each of the computer software applications may be executed by a computer processor, such as computer processor 206 or 226 of FIG. 3, may be stored in computer memory, such as computer memory 202 or 222 of FIG. 3, and may be displayed on a computer display, such as computer displays 208 or 228 of FIG. 3. Each of the computer software applications 312, 314, 316, and 318 may be different from one another. The computer software applications 312, 314, 316, and 318 communicate with and/or are linked to a basic integration layer 310. The basic integration layer 310 may include computer software executed by a computer processor such as 206 and/or 226, stored in a computer memory such as 202 and/or 222, and displayed on a computer display, such as 208 and/or 228. The basic integration layer 310 may integrate the applications 312, 314, 316, and 318 together. The basic integration layer 310 may be linked to and/or may communicate with further layer 308.

The further layer 308 may include computer software executed by a computer processor such as 206 and/or 226, stored in a computer memory such as 202 and/or 222, and displayed on a computer display, such as 208 and/or 228. The further layer 308 may integrate the applications 312, 314, 316, and 318 together. The further layer 308 may be linked to and/or may communicate with data cluster 306.

The data cluster 306 may communicate to a computer and/or computer monitor 302 information which may be appear in window 304. The computer display 208 and/or 228 may be the computer monitor 302.

The method and/or apparatus shown by FIG. 4, takes advantage of the fact that a certain set of data typically has be to retrieved every time a customer service representative receives a customer call, and this data can be saved in the data cluster 306 in computer memory 202 and/or 222. This data typically pertains to the profile information of the subscriber, his or her geographical information and his or her personal details. This information rarely changes during the lifecycle of the subscriber. The present application, in at least one embodiment, provides a smart data cache cluster for cluster 306, where the information for the customer which is anticipated to be required, is stored and can be retrieved very quickly from data cluster 306 in memory 202 and/or 222 without any dependency on the underlying system of computer software applications 312, 314, 316, and 318.

In at least one or more embodiments, the method and apparatus shown by FIG. 4, has many advantages. For example, firstly, a significant set of customer information data, in at least one embodiment, is stored in the cache or data cluster 306 in memory 202 and/or 222, thus enabling a quick retrieval of data by the customer service representative by using interactive device 204 and/or 224, without having to connect to computer software application and/or underlying system, such as 312, 314, 316, and 318. Secondly, there is a reduced load on the underlying systems or underlying computer software applications 312, 314, 316, and 318 due to lesser frequency of hits. Thirdly, even if an underlying system or underlying computer software applications 312, 314, 316, and 318 is down, the information available in the cache cluster of data cluster 306 stored in memory 202 and/or 222, can still be displayed on computer display 208 and/or 228 using interactive device 204 and/or 224.

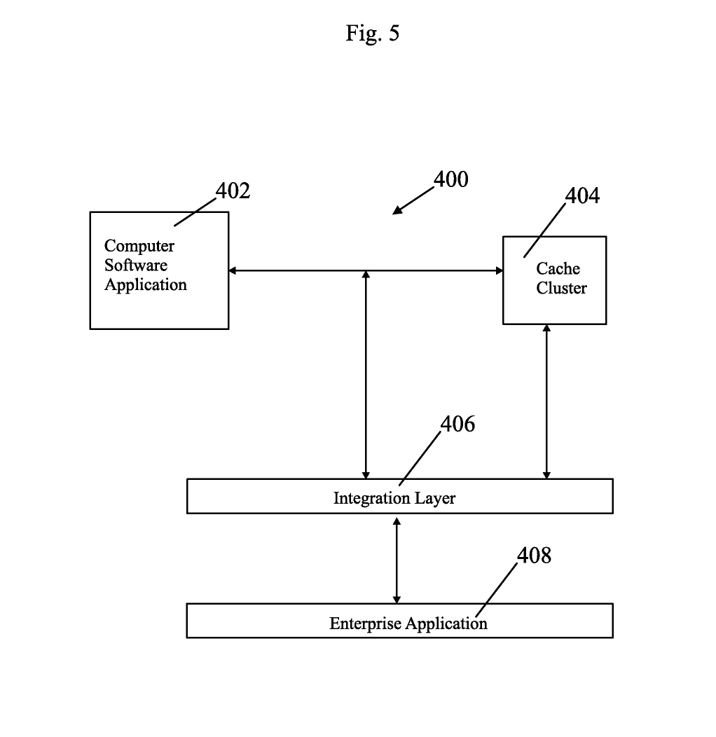

FIG. 5 shows a block diagram 400 of another apparatus and/or method for organizing multiple computer software applications accessed by a customer service representative in accordance with one or more further embodiments of the present invention.

The block diagram 400 includes an Enterprise Application 408 which may be one of the computer software applications 312, 314, 316, and 318. It includes the computer software application 402 may be programmed by computer software stored in computer memory 202 and/or 222 to provide data to a cache cluster or data cluster 404 which may be the same as data cluster 306 shown in FIG. 4, and stored in memory 202 and/or 222.

The block diagram 400 may also include an integration layer 406 which may provide data to the cache cluster 404. The integration layer 406 may include layers 308 and 310 shown in FIG. 4.

One or more embodiments of the present invention, such as shown by FIGS. 4 and 5, may be a mix of mash-up solution (as known previously and discussed with reference to FIG. 2) and a localized solution which provides the communication service provider (CSP) with more robust architecture, delivery of right information at right time, with minimal dependency on the enterprise. Based on the typical customer interactions that happen at a contact or call center, it is quite critical that the processes that are involved in addressing queries and transactions are addressed effectively.

One or more embodiments of the present invention, provide a computer processor, such as 206 and/or 226, which is programmed by computer software stored in computer memory 202 and/or 222 to deal which various interactions in the following manner.

In at least one embodiment, all customer information is managed locally in its own cache cluster 404 (or 306), without integration/probing an Integration layer 406 or enterprise application 408 for each call by a customer, thus providing a faster response. In the present application, generally, an enterprise application or an enterprise computer software application is typically a computer software application program running in an information technology (IT) environment of the communication service provider (CSP). In accordance with at least one embodiment of the present invention, an enterprise application or an enterprise computer software application, such as enterprise application 408 in FIG. 5 includes a computer software program which is a customer relationship management (CRM) system which contains customer demographic data.

For some customer related information which is not stored in Data cache cluster 404, routing logic, stored as a computer program in user computer memory 202 and/or server computer memory 222 is used to get the information directly from an enterprise application (such as computer software application 312, 314, 316,318 in FIG. 4 or enterprise application 408 in FIG. 5). Integration layer 406, in at least one embodiment, is a combination of basic integration layer 310 shown in FIG. 4, further layer 308 shown in FIG. 4, and basic integration layer 108 shown in FIG. 2. Enterprise application 408, in at least one embodiment, may include one or more of the computer software applications or application programs 312, 314, 316, and 318 shown in FIG. 4, and 110, 112, 114, and 116 shown in FIG. 2, and 14, 16, 18, and 20, shown in FIG. 1, respectively.

For transactions like creation of a service request, which are defined as any write operation on to base/legacy enterprise applications such enterprise application 408, as in at least one embodiment, the computer processor 206 and/or 226 may be programmed by computer software stored in computer memory 222 to use a similar methodology of recording a transaction such as by storing data regarding it in computer memory 222, and routing the transaction asynchronously via an integration suite to an enterprise application such as 408, which is same as computer software application described in FIGS. 4, 2, 1 with 312, 314, 316, 318 and 110,112,114,116 and 14, 16, 18, 20 respectively.

An apparatus and/or method in accordance with an embodiment of the present invention may include a cache cluster 404 (or 306) which may be stored in a region of computer memory 222. The cache cluster 404 (or 306) may be built using or on an open source search engine library such as LUCENE (trademarked). The computer memory 222 may have a computer program stored therein, which is implemented by the server computer processor 226, to store in the cache cluster 404 (or 306) in the computer memory 222, the latest information for a customer, such as profile, address, payments, invoices, as orders.

The customer information in the cache cluster 404 (or 306) is programmed to be updated by the computer processor 226 from the enterprise, i.e., the data cache cluster is created via data migration of desired customer information from enterprise application for the first time and all subsequent updates of customer information in cluster 404 (or 306) may be done via the Integration layer 406, which may be a computer program stored in server computer memory 222, and executed by server computer processor 226.

Every time a change happens on the (relevant) information stored in enterprise application, the enterprise application itself and/or another program component will send a message to the Integration suite. The cache cluster 404 (or 306) is configured as another client for the server computer processor 226 to read and/or update the cache cluster 404 and/or 306 in the server computer memory 222. All information updates would be updated asynchronously by the computer processor 226, in at least one embodiment, as programmed, into the cache cluster 404.

When information as requested is not available in cache cluster 404, the computer processor 206 and/or 226 is programmed by computer software stored in memory 202 and/or 222 to request the relevant enterprise via the integration layer 406.

An application user interface, which is displayed on the computer display 208, in at least one embodiment, is built on open source framework. This means that in at least one embodiment, the front end, or the user interface of the application is built and/or configured using open source computer software tools and technologies and not using any proprietary computer software tools.

The information as required for the customer service representative is represented and/or shown for all interactions, in at least one embodiment.

Computer display 208 displays information as per the roles and rights of the user or CSR (customer service representative) logged in.

Integration Layer 406. The application may also interface with the existing operator's Integration suite for all customer related information. The cache cluster 404 has built in message streams to read relevant data inputs/messages for indexing,

One or more embodiments of the present application have the following advantages. There is a focus on customer experience. The customer service representative (CSR) could also use the same system, provided through the information from integrated computer software application 304, to push information back into the underlying systems, such as computer software applications 110, 112, 114, and 116.

A significant set of customer information data, in at least one embodiment, is stored in the cache or data cluster 306 in memory 202 and/or 222, thus enabling a quick retrieval of data by the customer service representative by using interactive device 204 and/or 224, without having to connect to computer software application and/or underlying system, such as 312, 314, 316, and 318. Secondly, there is a reduced load on the underlying systems or underlying computer software applications 312, 314, 316, and 318 due to lesser frequency of hits. Thirdly, even if an underlying system or underlying computer software applications 312, 314, 316, and 318 is down, the information available in the cache cluster of data cluster 306 stored in memory 202 and/or 222, can still be displayed on computer display 208 and/or 228 using interactive device 204 and/or 224.

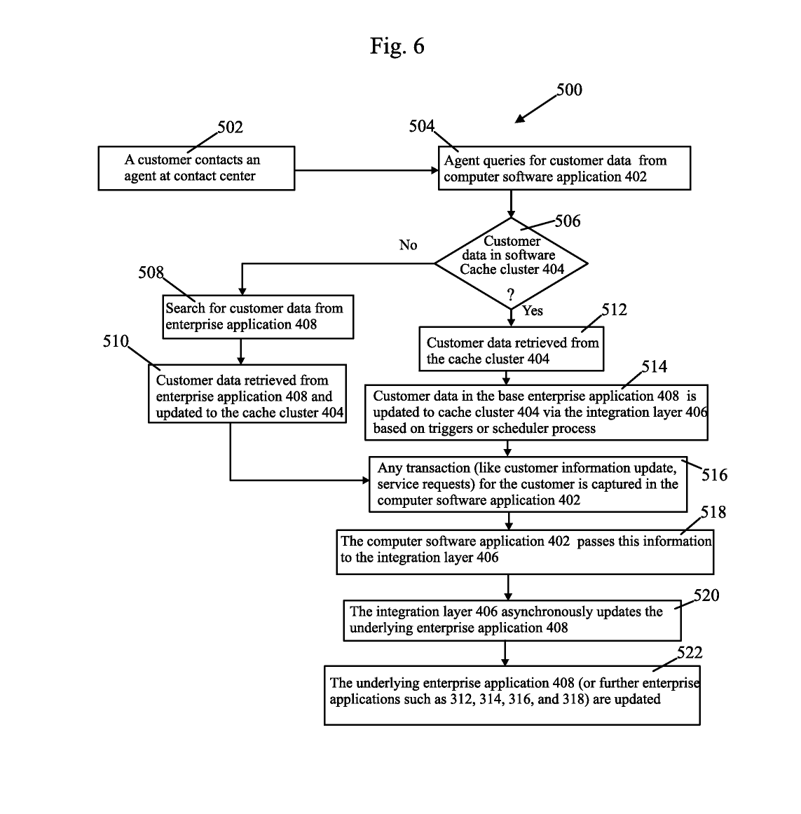

FIG. 6 shows a block diagram of a flow chart 500 of a method in accordance with one or more embodiments of the present invention.

At step 502 a customer contacts an agent at a contact center. For example, a customer using a telephone, such as a cell telephone, may call a contact center telephone number to speak to an agent. The agent may verbally ask the customer for data relating to the customer, such as name, address, phone number, or other customer data. The agent may then user the user computer interactive device 204, such as a computer mouse, computer keyboard, or computer touch screen, to cause the user computer processor 206 to request customer data from the server computer 220 through the port 210, internet 212, and the port 230, shown in FIG. 3, from the computer software application 402 of FIG. 5, which may be executed by the server computer processor 226 and stored in the server computer memory 222.

The server computer processor 226 may be programmed to determine at step 506, as part of the computer software application 402, whether the customer data is in software cache cluster or computer memory 404. The cache cluster 404 may be a designated region of server computer memory 222.

If the customer data is not in cache cluster 404, then the server computer processor 226 may be programmed to search for the customer data from enterprise computer software application 408 of FIG. 5, at step 508 of FIG. 6. The customer data may be retrieved from the enterprise computer software application 408 at step 510 and then stored in or updated to cache cluster 404, at step 510.

If the customer data is in cache cluster 404, then the server computer processor 226 may be programmed to retrieve the customer data from the cache cluster at step 512 of FIG. 6. Based on a trigger computer software mechanism or scheduler computer software mechanism, the server computer processor 226 may be programmed to update customer data stored in the base enterprise application 408 with the customer data which has been retrieved from the cache cluster at step 512. Step 514 may be done via the integration layer 406.

At step 516, any transaction, such as a customer data or information update or a service request for the customer, is captured in the server computer memory 222 in computer memory designated for the computer software application 402 of FIG. 5. At step 518, the computer software application 402 passes the updated information to the integration layer 406. At step 520, the integration layer 406, which may be a computer program stored in computer memory 222 and implemented by the server computer memory 226, may be programmed to asynchronously update the underlying enterprise application 408. At step 522, the integration layer 406, as implemented by the server computer processor 226, may be programmed to update further enterprise applications such as 312, 314, 316, and 318 of FIG. 4, such as with updated customer information which was retrieved by the server computer processor 226 from cache 404 at step 512 or from enterprise application 408 at step 510.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising:
receiving a telecommunications call from a customer at a contact center;
in response to the telecommunications call, using a first user computer to request customer data from a software cache in a computer memory related to a first computer software application;
if the customer data is in the software cache, retrieving the customer data from the software cache and storing the customer data in a base enterprise computer software application; and
if the customer data is not in the software cache, searching for the customer data in the base enterprise computer software application, if the customer data is in the base enterprise computer software application, retrieving the customer data from the base enterprise computer software application and storing the customer data in the software cache in the computer memory related to the first computer software application.

2. An apparatus comprising:
a computer processor; and
a computer memory;
wherein the computer processor is programmed such that in response to a telecommunications call from a customer, the computer processor requests customer data related to the customer from a software cache in a computer memory related to a first computer software application;
wherein the computer processor is programmed, such that, if the customer data is in the software cache, the computer processor retrieves the customer data from the software cache and stores the customer data in a base enterprise computer software application; and
wherein the computer processor is programmed, such that, if the customer data is not in the software cache, the computer processor searches for the customer data in the base enterprise computer software application, and if the customer data is in the base enterprise computer software application, the computer processor retrieves the customer data from the base enterprise computer software application and stores the customer data in the software cache in the computer memory related to the first computer software application.
